(19) United States
(12) Patent Application Publication
(10) Pub. No.: US 2007/0116364 A1
(43) Pub. Date: May 24, 2007

(54) Apparatus and method for feature recognition

(76) Inventors: Richard P. Kleihorst, Neerpelt (BE); Hasan Ebrahimmalek, Purmerend (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,443

(22) PCT Filed: Sep. 7, 2004
(86) PCT No.: PCT/IB04/51699

§ 371 Date: Jan. 25, 2007

(30) Foreign Application Priority Data
Sep. 10, 2003 (EP) 03103334.3

(51) Int. Cl. G06K 9/46

(52) U.S. Cl. 382/190

(57) ABSTRACT

A face recognition system comprising an image sensor (100), the output of which is fed to a detection module (102) and the output of the detection module (102) is fed to a recognition module (104). The detection module (102) can detect and localize an unknown number (if any) of faces. The main part of the procedure entails segmentation, i.e. selecting the regions of possible faces in the image. Afterwards, the results may be made more reliable by removing regions which are too small and by enforcing a certain aspect ration of the selected regions of interest The recognition module (104) matches data received from the detection module (102) to data stored in its database of known features and the identity of the associated subject is forwarded to the output of the system, provided the “match” is determined to be above a predetermined reliability level, together with a signal indicating the level of reliability of the output The system further includes an analyzer (106) and, in the event that the level of reliability of the output is determined to be below a predetermined threshold (set by comparator (108), the output of the detection module (102) is also fed to the analyzer (106). The analyzer (106) evaluates at least some of the data from the detection module (102), to determine the reason for the low reliability, and outputs a signal to a speech synthesizer (110) to cause a verbal instruction to the subject to be issued, for example, “move closer to the camera”, “move to the left/right”, etc. If and when the reliability of the output reaches the predetermined threshold, this may be indicated to the subject by, for example, a verbal greeting.

This invention relates to an apparatus and method for feature recognition and, more particularly, to an apparatus and method for face recognition in, for example, surveillance or identification systems.

There is a rapidly growing demand for cameras including built-in intelligence for various purposes like surveillance and identification. In recent years, face recognition has become an important application in respect of such cameras. Face recognition is one of the visual tasks which humans can do almost effortlessly, but which for computers it poses a challenging and difficult technical problem.

The applications of face recognition are increasing in a number of fields, for example, user identification as a form of ambient intelligence for access control as an alternative to pincodes and for adapting parameters of machines, such as PC settings, or as part of a surveillance system.

Currently, most face recognition systems employ previously-captured video, rather than working at video speed. There are some systems currently available which can perform on-the-fly face recognition from captured video streams, and demand for such systems is increasing rapidly. However, these systems tend to be unreliable and cumbersome, not necessarily due to the processes used for face recognition, but due to the “suitability” of the scene and the related captured image.

A recognition process may, for example, be unreliable if the sub-image used in the detection process is too small, because the subject is too far away from the camera, or in the case where the subject is not fully within the field of view of the camera. In current systems, the only way to determine this is to look at the intermediate signals on a computer screen, and the only way to rectify it is for the subject to walk around and stand in different positions relative to the camera until the grabbed image is good enough for recognition purposes.

U.S. Pat. No. 6,134,339 describes a method and apparatus for determining the position of eyes and for correcting eye defects in a captured image frame, comprising a red eye detector for identifying eyes within the image frame, means for determining whether or not the detected pairs of eyes satisfy all of some predetermined criteria and, if not, for outputting some form of error code. In one described embodiment, the system may be arranged to output an audio signal (e.g. a “beep”) to indicate that the position of the detected eyes within the captured image is optimal.

We have now devised an improved arrangement.

In accordance with the present invention, there is provided apparatus for feature recognition, the apparatus comprising:

image capture means for capturing an image within its field of view;

detection means for identifying the presence of a subject within said image and for detecting one or more features of said subject;

recognition means for matching said one or more features to stored feature data; and

means for determining whether or not said captured image is sufficient for the purpose of feature recognition; characterized by:

means for generating and issuing instructions to said subject relating to required movement of said subject within said field of view, in the event that said captured image is determined not to be sufficient for the purpose of feature recognition, said instructions being designed to aid said subject in positioning themselves within said field of view such that a sufficient image can be captured.

In a preferred embodiment, the instructions comprise audio signals, preferably in the form of speech signals instructing the subject as to the direction in which they are required to move relative to the image capture device.

Apparatus according to a third embodiment of the invention comprises a detection module and a recognition module for outputting data relating to the subject, together with data indicating the reliability of said output data. Means may be provided for comparing the reliability data with a predetermined threshold so as to determine whether or not a sufficient image was captured. Preferably, an analyzer is provided for determining the action required to be taken by the subject in order that a sufficient image can be captured, and for providing corresponding data to the means for issuing instructions to the subject.

The detection module is preferably configured to identify one or more features within a captured image and provide data relating to the location of the one or more features to the recognition module. The recognition module preferably includes a database of features, and means for comparing feature data received from the detection module with the contents of the database to determine a match.

Also in accordance with the present invention, there is provided a method of feature recognition, the method comprising the steps of:

capturing an image within the field of view of image capture means;

identifying the presence of a subject within said image and detecting one or more features of said subject;

matching said one or more features to stored feature data; and

determining whether or not said captured image is sufficient for the purpose of feature recognition; characterized by the step of:

providing means for automatically generating and issuing instructions to said subject relating to required movement of said subject within said field of view, in the event that said captured image is determined not to be sufficient for the purpose of feature recognition, said instructions being designed to aid said subject in positioning themselves within said field of view such that a sufficient image can be captured.

Thus, the present invention provides an apparatus and method for a user friendly and intuitive face recognition system, in the sense that it analyses the captured image and the position of the subject therein, determines if the quality of the image of the subject is sufficient for the purpose of feature recognition and, if not, determines how the subject needs to move within the field of view to enable an image of sufficient quality to be captured, and generates and issues instructions (i.e. “feedback”) to the subject to guide the subject to the correct position to be recognized by the system.

By including a feedback system (preferably in the form of speech) within a feature recognition system, the typical deficiencies of prior art face recognition systems, such as the subjects face being too small within the captured image for reliable recognition or the subject being slightly out of range of the camera's field of view, can be overcome in an elegant, quick and user friendly (intuitive) way. The system could, for example, be arranged to ask the subject to come closer, move to the side in one direction or another, or look straight into the camera. The system may also be arranged to give a greeting (again, preferably in the form of speech) to indicate that a subject has been successfully recognized. In this way, the need for zoom lenses, moving cameras and technical feedback circuits required by prior art systems can be eliminated.

These and other aspects of the present invention will be apparent from, and elucidated with reference to, the embodiment described hereinafter.

An embodiment of the present invention will now be described by way of example only and with reference to the accompanying drawings, in which:

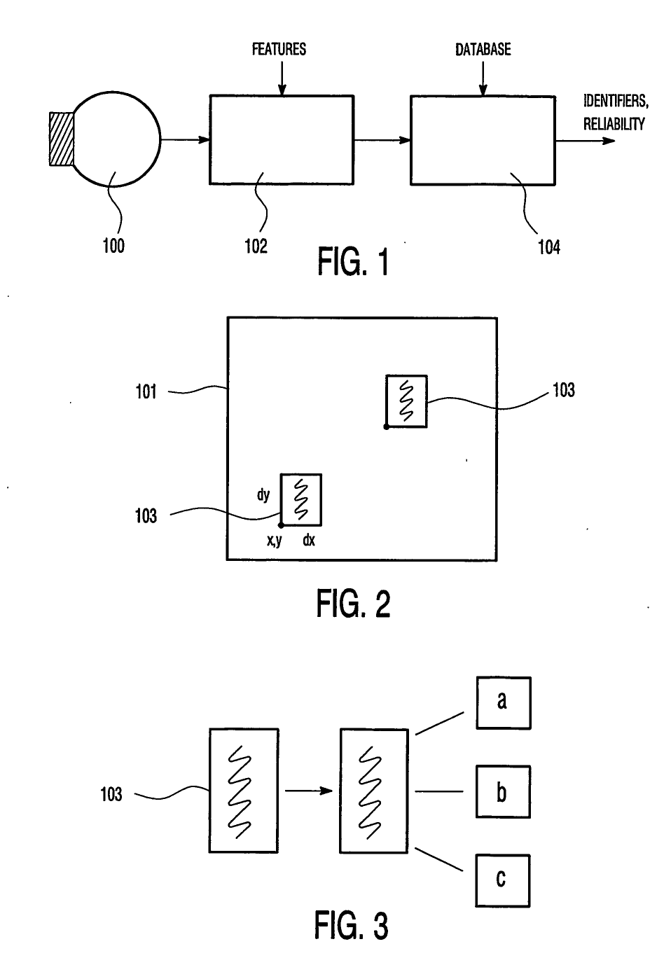

FIG. 1 is a schematic block diagram illustrating the configuration of a typical face recognition system according to the prior art;

FIG. 2 is a schematic representation of the operation employed by the detection module of FIG. 1;

FIG. 3 is a schematic representation of the match process performed by the recognition module of FIG. 1;

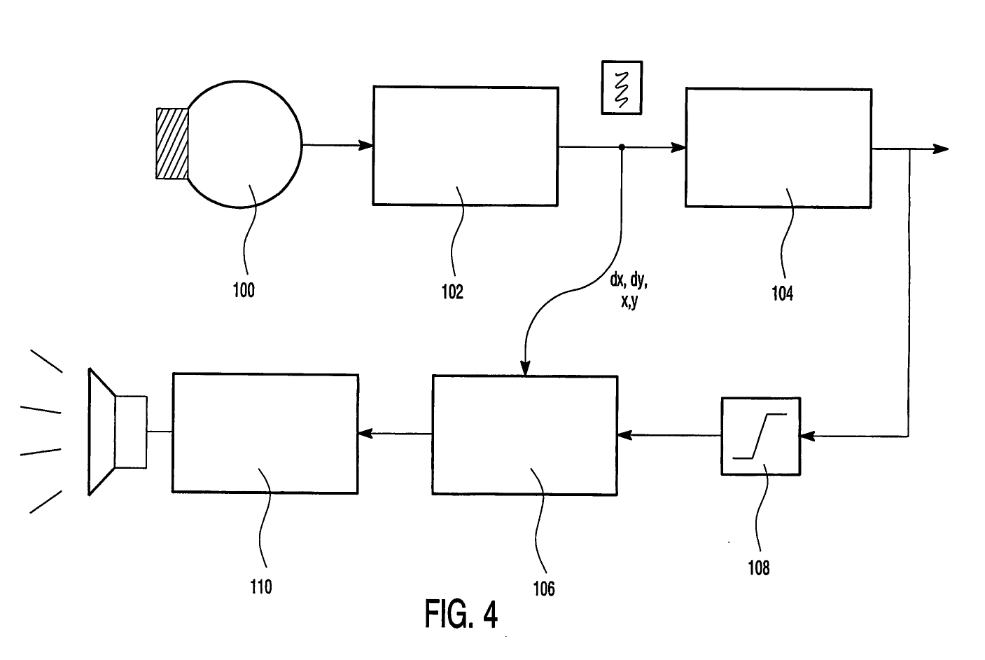

FIG. 4 is a schematic block diagram illustrating the configuration of a face recognition system according to an exemplary embodiment of the present invention.

Referring to FIG. 1 of the drawings, a typical face recognition system according to the prior art comprises an image sensor 100 for capturing an image (101—FIG. 2) of the scene within its field of view, and the output from the image sensor 100 is input to a detection module 102. The detection module 102 detects and localizes an unknown number (if any) of faces within the captured scene, and the main part of this procedure entails segmentation, i.e. selecting regions of possible faces within the scene. This is achieved by detecting certain “features” in the scene, such as “eyes”, “brow shapes” or skin tone colors. The detection module 102 then creates sub-images 103 of dimension dx, dy and position x, y (as shown in FIG. 2 of the drawings) and sends them to a recognition module 104.

The recognition module might scale the or each sub-image 103 received from the detection module 102 to its own preferred format, and then matches it to data stored in its database of known features (see FIG. 3). It compares the or each sub-image 103 to stored sub-images a, b and c, identifies the stored sub-image which a sub-image 103 most matches, and the identity of the associated subject is forwarded to the output of the system, provided the “match” is determined to be above a predetermined reliability level, together with a signal indicating the level of reliability of the output.

However, as stated above, most current face recognition systems tend to be unreliable and cumbersome, not necessarily due to the processes used for face recognition, but due to the “suitability” of the scene and the related captured image.

A recognition process may, for example, be unreliable if the sub-image used in the detection process is too small, because the subject is too far away from the camera, or in the case where the subject is not fully within the field of view of the camera. In current systems, the only way to determine this is to look at the intermediate signals on a computer screen, and the only way to rectify it is for the subject to walk around and stand in different positions relative to the camera until the grabbed image is good enough for recognition purposes.

Referring to FIG. 4 of the drawings, a face recognition system according to an exemplary embodiment of the present invention, comprises an image sensor 100, the output of which is fed to a detection module 102, as before. The detection module 102 operates in the same way as the corresponding module of the system illustrated in and described with reference to FIG. 1, and the output of the detection module 102 (i.e. the one or more identified sub-images) is fed to the recognition module 104, as before.

In more detail, given an image (from a video sequence), the detection module can detect and localize an unknown number (if any) of faces. The main part of the procedure entails segmentation, i.e. selecting the regions of possible faces in the image. In one embodiment of the invention, this may be done by color specific selection (e.g. the detection module 104 may be arranged to detect faces in the captured image by searching for the presence of skin-tone colored pixels or groups of pixels). Afterwards, the results may be made more reliable by removing regions which are too small and by enforcing a certain aspect ration of the selected regions of interest.

Once again, the recognition module might scale the or each sub-image received from the detection module 102 to its own preferred format, and then matches it to data stored in its database of known features (see FIG. 3). It compares the or each sub-image to stored sub-images a, b and c, identifies the stored sub-image which a sub-image most matches, and the identity of the associated subject is forwarded to the output of the system, provided the “match” is determined to be above a predetermined reliability level, together with a signal indicating the level of reliability of the output.

Thus, through the face recognition process, the face(s) detected by the detection module is (are) identified with respect to the face database. For this purpose, a Radial Basis Function (RBF) neural network may be used. The reason behind using a RBF neural network is its ability for clustering similar images before classifying them, as well as its fast learning speed and compact topology (see J. Haddadnia, K. Faez and P. Moallem, “Human Face Recognition with Moment Invariants Based on Shape Information”, in Proceedings of the International Conference on Information Systems, Analysis and Synthesis, vol. 20, (Orlando, Fla., USA), International Institute of Informatics and Systematics (ISAS'2001)).

The system further includes an analyzer 106 and, in the event that the level of reliability of the output is determined to be below a predetermined threshold (set by comparator 108), the output of the detection module 102 is also fed to the analyzer 106. The analyzer 106 evaluates at least some of the data from the detection module 102, to determine the reason for the low reliability, and outputs a signal to a speech synthesizer 110 to cause a verbal instruction to the subject to be issued, for example, “move closer to the camera”, “move to your left/right”, etc. If and when the reliability of the output reaches the predetermined threshold, this may be indicated to the subject by, for example, a verbal greeting such as “Hello, Mr Green”.

Thus, the system described above provides feedback to the user (by way of spoken instructions or greeting), which is very intuitive and the spoken instructions will lead the person to the right position to be recognized in a user friendly way.

In one embodiment, the software code running in the analyzer may be as follows:

if ((dx < 5g pixels) OR (dy < 6g pixels))
then speak (“come closer please”)
else if (x = 0) then speak (“move left”)
else if (x = 63g) then speak (“move right”)
else if (reliability > threshold)
speak (“hello”, name_from_database(identifier))
end

Thus, in summary, face recognition has, in the past, been a challenging task, particularly in the field of cybertronics. It is difficult because, for robust recognition, the face needs to be at a proper angle and completely in front of the camera. Also, the size of the face in the captured image has to span a minimum number of pixels because, if the face portion does not contain enough pixels, reliable detection and recognition cannot be achieved. If the face is not completely within the field of view of the camera (e.g. too far to the left or too far to the right), the same problem holds.

If a user is provided with feedback within prior art systems, such feedback is of a technical nature, such as intermediate images in the processing chain. No practical feedback is provided. In the exemplary embodiment described above, the present invention provides a face recognition system which includes audible feedback using speech synthesis. Thus, if the face is too small within the captured image, the system may be arranged to output “come closer”, or “move left please” for sideways movement, or “look here please!”. Thus, the present invention provides a very intuitive user interface system and, because the images are better controlled compared with prior art systems, the recognition capability is significantly improved.

It will be appreciated that many different feature recognition techniques will be known to a person skilled in the art, and the present invention is not intended to be limited in this regard.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. Apparatus for feature recognition, the apparatus comprising:
image capture means (100) for capturing an image (101) within its field of view;
detection means (102) for identifying the presence of a subject within said image and for detecting one or more features of said subject;
recognition means (104) for matching said one or more features to stored feature data; and
means (108) for determining whether or not said captured image (101) is sufficient for the purpose of feature recognition; characterized by:
means (106, 110) for generating and issuing instructions to said subject relating to required movement of said subject within said field of view, in the event that said captured image (101) is determined not to be sufficient for the purpose of feature recognition, said instructions being designed to aid said subject in positioning themselves within said field of view such that a sufficient image can be captured.

2. Apparatus according to claim 1, wherein said instructions comprise audio signals.

3. Apparatus according to claim 2, wherein said audio signals are provided by a speech synthesizer (110) which outputs spoken instructions to said subject.

4. Apparatus according to claim 1, comprising a detection module (102) and a recognition module (104) for outputting data relating to the subject, together with data indicating the reliability of said output data.

5. Apparatus according to claim 4, comprising means (108) for comparing said reliability data with a predetermined threshold so as to determine whether or not a sufficient image was captured.

6. Apparatus according to claim 1, comprising an analyzer (106) for determining the action required to be taken by the subject in order that a sufficient image can be captured, and providing corresponding data to said means (110) for issuing instructions to said subject.

7. Apparatus according to claim 4, wherein said detection module (102) is configured to identify one or more features within a captured image and provide data relating to the location of said one or more features to said recognition module.

8. Apparatus according to claim 7, wherein said recognition module (104) includes a database of features, and means for comparing feature data received from said detection module (102) with the contents of said database to determine a match.

9. A method of feature recognition, the method comprising the steps of:
capturing an image (101) within the field of view of image capture means;
identifying the presence of a subject within said image and detecting one or more features of said subject;
matching said one or more features to stored feature data; and
determining whether or not said captured image is sufficient for the purpose of feature recognition;
characterized by the step of:
providing means (106, 110) for automatically generating and issuing instructions to said subject relating to required movement of said subject within said field of view, in the event that said captured image is determined not to be sufficient for the purpose of feature recognition, said instructions being designed to aid said subject in positioning themselves within said field of view such that a sufficient image can be captured.
